(19) United States
(12) Patent Application Publication
(10) Pub. No.: US 2005/0039372 A1
(43) Pub. Date: Feb. 24, 2005

(54) Cast net with elastic wrist cuff

(76) Inventor: Joseph R. Amore, German Town, TN (US)

Correspondence Address: DONALD R. BAHR, 2608 MERIDA LN, TAMPA, FL, 33618, US

(21) Appl. No.: 10/643,443

(22) Filed: Aug. 18, 2003

(51) Int. Cl. A01K 73/00

(52) U.S. Cl. 43/8

(57) ABSTRACT

A cast net having a circular net portion the circumference of which is defined by a lead line. The cast net having a throw line one end of which is attached to the center of the net portion. The other end of the throw line comprises a flexible cuff which is adapted to be slipped over a human hand and engages a human wrist. The flexible cuff allows the throw line to disengage the human wrist by slipping over the hand. This disengagement can be effected simply and quickly in an emergency situation. The flexible cuff further adds a degree of comfort to the throwing process as it does not bind the wrist of the user.

### BACKGROUND OF THE INVENTION

This invention is concerned with cast nets. Cast nets are portable circular nets which are hand thrown. Cast nets are an ancient invention and have been used for thousands of years. The first cast nets were hand woven circular nets the outer edges of which were weighted with stones. A cast net generally comprises a circular net portion the outer periphery of which is weighted. The outer periphery is usually defined by a line on which the weights are strung. This outer line is called a lead line, as on all modern nets the weights are formed from lead and these lead weights are strung on a line which is attached to the circumference of the circular net.

On modern nets the center of the nets comprise a thimble through which are passed a plurality of brail lines. One end of each brail line is attached to the lead line the other end passes through the thimble and is attached to a throw line. The other end of the throw line is attached to the throwers hand. This attachment to the throwers hand is the subject of this invention. The attachment means of this invention adds both safety and comfort to the process of throwing a cast net.

### DESCRIPTION OF THE DRAWINGS

FIG. 1 is a side view showing an individual throwing a cast net on to the surface of a body of water.

FIG. 2 is a top plan view showing the component parts of a cast net.

FIG. 3 shows the prior art attachment of the throw line of a cast net to a throwers hand.

FIG. 4 shows the attachment of a throw line to a throwers hand in accordance with this invention.

FIG. 5 is a perspective view showing the hand cuff of the throw line in accordance with this invention.

FIG. 6 is a cut away side view showing the hand cuff of this invention.

FIG. 7 is a side view showing the hand cuff of this invention slipping off of a throwers hand.

### BRIEF DESCRIPTION OF THE INVENTION

Cast nets are circular nets which are thrown onto the surface of a body of water. The circumference of the circular net is weighted in order to make the outer periphery of the net sink to the bottom of the body of water. In this sinking process the center of the net balloons up in such a manner that any fish which are under the net are trapped. After throwing, and once the net reaches the bottom of the estuary the thrower pulls in the throw line thereby making it possible to capture any fish that might have been trapped under the net. On modern cast nets a plurality of brail lines cause the periphery of the net to fold in on itself, thereby preventing any entrapped fish from escaping.

In throwing the cast net if a large fish is entrapped serious problems can occur for the thrower. Typically the throw line of a cast net is attached to the wrist of the thrower and secured to the wrist of the thrower with a binding loop. If a large fish is entrapped this fish naturally tries to escape. In trying to escape the fish puts pressure on the throw line causing it to bind on the users hand. In this situation it is impossible for the throwers to disengage the throw line and hence the cast net. That is the harder the thrower and the entrapped large fish pull the tighter the throw line binds on the throwers wrist. This situation usually occurs when the thrown cast net entraps a large shark.

This invention is concerned with a cast net which incorporates a flexible cuff which can easily slip over and off of a throwers hand in the event there is a need to rapidly disengage the thrower from the thrown cast net. The flexible cuff of this invention adds both comfort and safety to the process of throwing a cast net.

Description of the Preferred Embodiment

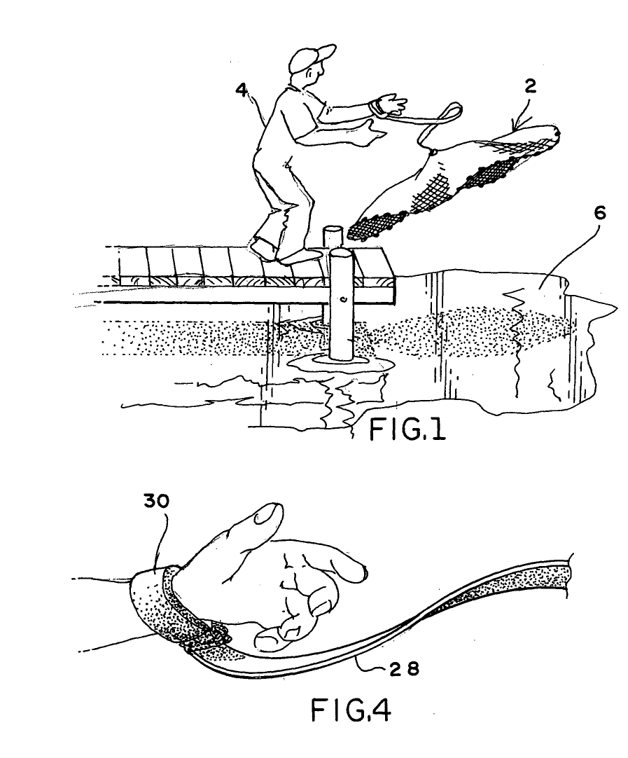

Referring to FIG. 1 it can be seen that a cast net 2 is a circular net which is meant to be thrown by a thrower 4. The throwing of a cast net takes a certain degree of skill as it is necessary to impart a circular motion to the net in order to make the net open up. The ability of a cast net to catch fish is directly proportional to the amount the cast net opens. If the cast net does not open, few if any fish will be entrapped and if any fish are entrapped there is a high probability that the entrapped fish will escape as the cast net settles in the water.

As a result of leg, waist, shoulder and hand action, on the part of the thrower, a cast net 2 can be made to open in a circular pattern as is shown in FIG. 1. Once cast net 2 touches the surface of water 6 the opening of cast net 2 is stopped and the pattern of the net is defined.

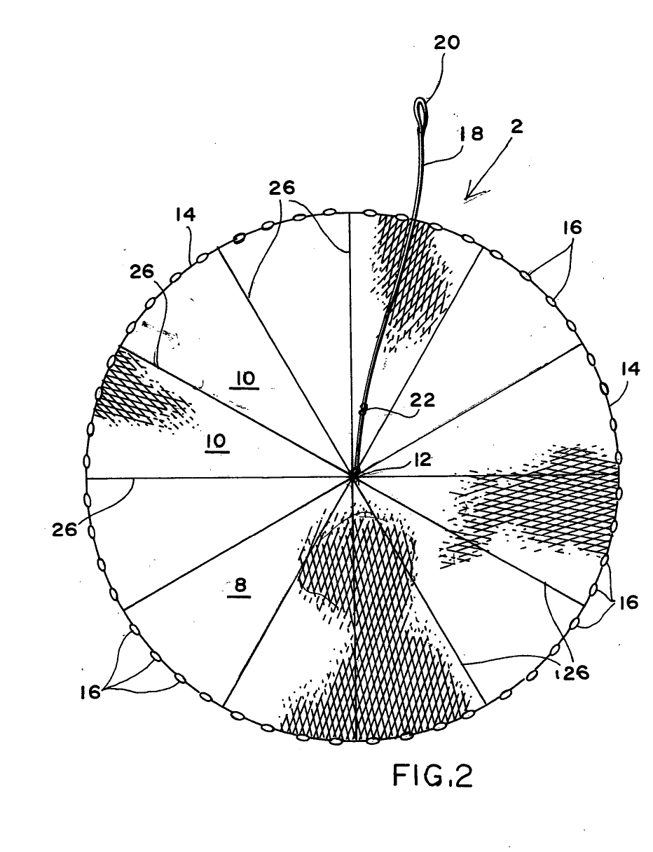

In order to better understand the subject invention, the parts and function of a cast net must be understood. Referring to FIG. 2 it can be seen that cast net 2 has a circular shape. The net portion 8 is formed from a plurality of pie shaped segments 10 which are sewn together. A thimble 12 is attached to the net portion 8 at the center of the net where pie shaped segments 10 converge. The outer circumference of cast net 2 is defined by a lead line 14 which is sewn to the outer periphery of net portion 8, a plurality of lead weights 16 are strung on lead line 14.

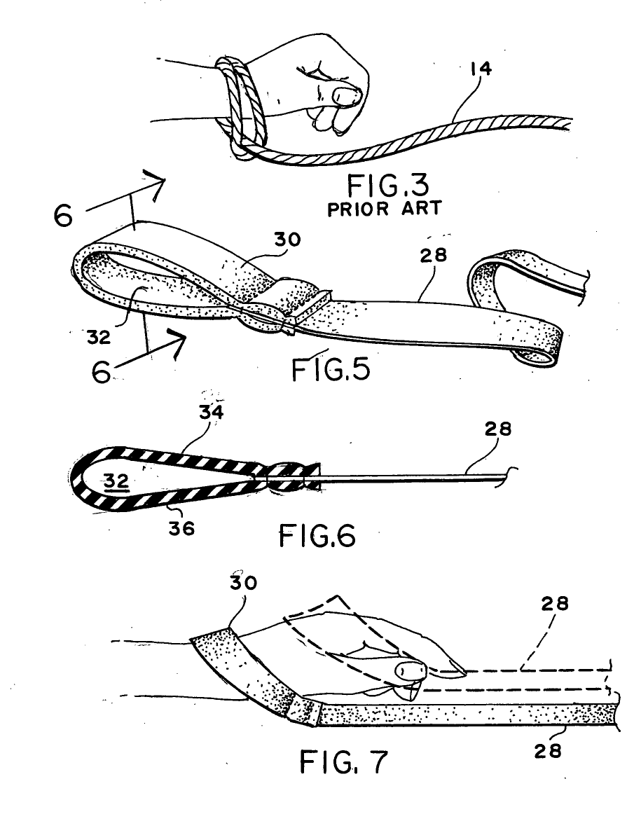

A throw line 18 is further provided for. One terminal end of throw line 18 incorporates a loop 20, which in the prior art is secured to a throwers wrist in a manner as is illustrated in FIG. 3. This prior art attachment tends to bind the users wrist which makes the throwing process somewhat discomforting.

The other terminal end of throw line 18 is attached via a swivel 22 to a plurality of brail lines 26, the other end of brail lines 26 being attached to lead line 14. As is mentioned above one terminal end of throw line 18 is attached to the throwers wrist via a binding loop 20. If the hand of the thrower is only inserted into loop 20, there is a possibility that the hand line will slip off of the throwers wrist during the complicated throwing sequence. This is an undesirable situation as if the throw line comes off of the throwers wrist the whole net assembly is lost. That is if the throw line slips off of the throwers wrist the composite cast net assembly will slip to the bottom of the estuary with no way to conveniently retrieve the same.

In order to prevent the throw line from slipping off of the users wrist it is recommended that the throw line be attached to the throwers wrist via a binding loop as is illustrated in FIG. 3. This binding adds discomfort to the throwing process.

The problem with the binding loop as is shown in FIG. 3, is that if in use the net encompasses a large fish, such as a large shark, the shark in trying to escape will put tension on throw line 14. As a result of this tension the loop as is shown in FIG. 3 binds on the throwers hand. The more tension is applied throw line 14 the more throw line 14 binds on the wrist of the thrower.

If a knife is not handy to cut throw line 14, dire consequences can result, such as the thrower being puller overboard.

The dangerous situation as described above creates a safety issue which is overcome in accordance with this invention. As can be seen in FIG. 4 throw line 28 is attached to a throwers wrist via a flexible cuff 30. Throw line 28 is illustrated as a piece of flexible webbing. The function of throw lines 14 and 28 is identical except that throw line 14 is formed from rope while throw line 28 is formed from webbing.

For use in accordance with this invention webbing is preferred as it has less of a tendency to kink as is compared to the rope of throw line 14. A piece of webbing having a width of ¾ inches and a length of 26 ft. is preferred for use in this invention.

Eye 32 of cuff 30 is of such a size that it just slightly binds the wrist of the thrower. As can be seen from FIGS. 5 and 6 cuff 30 is formed from a foamed polymeric material, such as a foamed Neoprene which is formed from a chloroprene rubber. The preferred thickness of the foam from which cuff 30 is formed is about 3.8 mm. For aesthetic reasons and in order to enhance durability, the outer surface of cuff 30 can comprise an elastic textile 34. It has been found that a width of about 2 inches is ideal for cuff 30.

The operations of flexible cuff 30 is illustrated in FIG. 7. As can be seen cuff 30 is secured on a user hand in a non binding fashion. Due to the elastic nature of cuff 30 it will not readily slip over the throwers hand.

As can be seen from the phantom illustration of FIG. 7 if excess tension is applied to throw line 28, such as in an emergency situation, cuff 30 will stretch in such a manner that it readily slips over the hand of the thrower, thereby effectively disconnecting the thrower from the cast net. This disconnect prevents the thrower from being pulled overboard and into the body of water into which the net has been thrown.

As can be seen from FIGS. 5 and 6 cuff 30 can be sewn to the webbing which comprises throw line 28. It is understood by one skilled in the art that other means can be used to attach the flexible cuff of this invention to the throw line.

It is preferred that elastic material 36 of cuff 30 be a closed cell, elastic material.

It is evident to one skilled in the art that flexible cuff 30 must be formed from a material which is rigid enough to grip the wrist of the user and yet not so rigid that the user is uncomfortable when the cuff is engaging the users wrist. That is cuff 30 can not be so ductile that it can not grip the users wrist and yet it can not be so rigid that it is uncomfortable when in place on the users wrist.

A satisfactory material from which to form cuff 30 is a Neoprene backed fabric having a thickness of about 0.187 inches.

The most important physical property of the material from which cuff 30 is found is the ability of this material to stretch. As is shown in FIG. 7 cuff 30 must stretch if it is going to pass over a users hand in an emerging situation. Stretch factors on the order of 50% have been found to be adequate. For example if the fabric from which cuff 30 will stretch 50% this is adequate for cuff 30 to slip over a users hand in an emergency situation. For purposes of this discussion a stretch factor of 50% means that the material from which cuff 30 is formed will stretch about 50% without rupturing, i.e. a 10 inch piece of relaxed material will stretch to 15 inches without rupturing.

While it is preferred that the material from which cuff 30 is formed have a stretch factor of about 50% it has been found that satisfactory cuff, for use in this invention, can have stretch factors of from about 25 to about 100%.

Further while cuff 30 is illustrated as a flat band it is understood that cuff 30 can be formed from elastic material having a circular cross section such as a bungee cord.

The close cell elastomeric material from which cuff 30, can be formed from any suitable elastic material such as natural rubber, synthetic rubber, silicone elastomers etc.

The above description and drawings are illustrative only since modifications can be made without departing from the present invention, the scope of which is to be limited only by the following claims.

1. A cast net having a substantially circular net portion, the circumference of which is defined by a lead line, which is secured to the net portion, the center of the net portion defining an apex, a throw line one terminal end of which is attached to the apex, the improvement which comprises; attaching a flexible cuff to the end of throw line opposite the apex, wherein, the flexible cuff is formed from an elastic material which is different than the material from which the throw line is formed and the flexible cuff is adapted to engage the wrist of a person throwing the cast net and secure the throw line to a users wrist.

2. The cast net of claim 1 wherein the flexible cuff comprises a loop of a flexible elastic material.

3. The cast net of claim 2 wherein the flexible cuff comprises an elastic band.

4. The cast net of claim 3 wherein the elastic band has a circular cross section.

5. The cast net of claim 3 wherein the elastic band has a rectangular cross section.

6. The cast net of claim 3 wherein elastic band is formed from a flexible, cellular, polymeric material.

7. The cast net of claim 4 wherein elastic band is formed from a flexible, cellular, polymeric material.

8. The cast net of claim 5 wherein elastic band is formed from a flexible, cellular polymeric material.

9. The cast net of claim 3 wherein at least one surface of the elastic band comprises a stretchable textile material.

10. The cast net of claim 5 wherein at least one surface of the elastic band comprises a stretchable textile material.

11. The cast net of claim 6 wherein at least one surface of the elastic band comprises a stretchable textile material.

12. The cast net of claim 7 wherein at least one surface of the elastic band comprises a stretchable textile material.

13. The cast net of claim 8 wherein at least one surface of the elastic band comprises a stretchable textile material.

14. The cast net of claim 6 wherein the cellular polymeric material is closed cell and has a stretch factor of about 50%.

15. The cast net of claim 7 wherein the cellular polymeric material is closed cell, and has a stretch factor of about 50%.

16. The cast net of claim 8 wherein the cellular polymeric is closed cell and has a stretch factor of about 50%.

17. The cast net of claim 12 wherein the cellular polymeric material is closed cell and has a stretch factor of about 50%.

18. The cast net of claim 13 wherein the cellular polymeric material is closed cell and has a stretch factor of about 50%.

19. The cast net of claim 1 wherein the throw line is formed from a length of webbing material.

20. The cast net of claim 8 wherein the throw line is formed from a webbing material.
